(19) United States
(12) Patent Application Publication
(10) Pub. No.: US 2009/0080076 A1
(43) Pub. Date: Mar. 26, 2009

(54) Apparatus housing and apparatus decoration with interference color film

(75) Inventors: Katsuhiro Fujikura, Aichi-ken (JP); Mamoru Kato, Aichi-ken (JP); Hiroshi Watarai, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/219,959

(22) Filed: Jul. 31, 2008

(30) Foreign Application Priority Data
Sep. 26, 2007 (JP) 2007-249477

(51) Int. Cl. G02B 1/10

(52) U.S. Cl. 359/585

(57) ABSTRACT

The present invention provides an apparatus housing and an apparatus decoration colored by a color luminous designed film. The color luminous designed film includes a semi-transparent metal coating film, a light interference transparent film which has an optical thickness of 5 to 150 nm and is formed from an inorganic compound under the semi-transparent metal coating film, and a ray reflective metal coating film under the light interference transparent film.

### TECHNICAL FIELD

The present invention relates to an apparatus housing and an apparatus decoration colored by an interference color film, which is colored by light interference.

### BACKGROUND OF THE INVENTION

Manufactured products often have colored surfaces or the like for improved design. An oft-used method for coloring coats a surface or the like with a coating that includes a colorant such as a pigment or a dye to form a film.

Other methods that do not use a colorant such as a pigment or a dye may instead utilize light interference. Such proposed methods include a method where one or both surfaces of a formed part (e.g. a film, sheet, or paper) includes an iridescent layer formed from a ray reflective film, a thin transparent film consisting of a metallic compound (thickness: 60 to 500 nm), and a translucent metallic film deposited by evaporation (Japanese Patent Application Publication No. JP-A-S61-015962); a method where a surface of a fabric has a rainbow-colored gloss obtained by laminating a first metal evaporated layer, a evaporated layer of a transparent compound (thickness: 100 to 500 nm), and a second metal evaporated layer in serial order (Japanese Patent Application Publication No. JP-A-H07-252773); and a method where at least one surface of a textile fabric is laminated in serial order with a reflective metal film, a transparent metal compound film (thickness: 40 to 500 nm), and a semi-transparent metal film (Japanese Patent Application Publication No. JP-A-H03-082881).

### SUMMARY OF THE INVENTION

However, the interference color films disclosed in JP-A-S61-015962 and JP-A-H07-252773 are such that the coloring of the targeted object changes depending on the iridescence, i.e., a light incident angle and a view angle. With the interference color film disclosed in JP-A-H03-082881, the coloring of a fiber-like object (with curvature) whose surface has been layered with an interference color film does not change depending on the view direction or the like, however, the coloring of a flat-like object such as a film does change.

Hence, it is an object of the present invention to provide an apparatus housing and an apparatus decoration that are colored by an interference color film (a color luminous designed film), which hardly generates color changes (rainbow coloring) caused by a change in a view direction (angle) or by different thicknesses of interference color films (particularly light interference transparent films) resulting from a shape or the like of a colored object.

In order to achieve the above object, an apparatus housing and an apparatus decoration according to the present invention comprise a color luminous designed film which colors the apparatus housing and the apparatus decoration, the color luminous designed film including: a semi-transparent metal coating film; a light interference transparent film which has an optical thickness of 5 to 150 nm and is formed from an inorganic compound under the semi-transparent metal coating film; and a ray reflective metal coating film under the light interference transparent film.

Using two interference colors for coloring enables more coloring of the apparatus housing and the apparatus decoration. Therefore, the color luminous designed film preferably includes a second transparent film for light interference formed from an inorganic compound on the semi-transparent metal coating film.

A surface layer formed from transparent resin or glass is preferably included on the color luminous designed film, since such a surface layer can serve as a substrate and facilitate formation of the color luminous designed film.

In addition, it is preferable that the inorganic compound is a dielectric, and the ray reflective metal coating film is a film with a discontinuous structure, whereby the apparatus housing and the apparatus decoration have electromagnetic permeability. This enables application in a housing and a decoration used for an apparatus that transmits or receives, or both transmits and receives electromagnetic waves.

Forms for respective elements of the present invention are exemplified as follows.

### 1. Semi-Transparent Metal Coating Film

The semi-transparent metal coating film, which is a film formed from a metal and reflects a portion of irradiated light and also transmits a portion of such light, is not particularly limited. However, from the standpoint of easily obtaining an interference color, 10 to 90% light transmittance ina (visible light) wavelength range of 400 to 800 nm is preferable. In addition, 3 to 60% light reflectance in the wavelength range of 400 to 800 nm is also preferable from the standpoint of easily obtaining an interference color, and 5 to 30% is more preferable in terms of obtaining an interference color with high brightness.

Although the semi-transparent metal coating film is not particularly limited, the semi-transparent metal coating film may be a film with a discontinuous structure (a sea-island film), in which there are spaces between the metal particles and the structure (the sea-island structure) lacks continuity. Alternatively, the semi-transparent metal coating film may be a continuous film, in which there are no spaces between the metal particles and the structure has continuity.

The thickness of the film with a discontinuous structure is not particularly limited and may vary depending on the type of metal structuring the film, but a thickness of 2 to 50 nm is preferable. For example, in the case of a film formed with indium, a thickness of 3 to 15 nm is preferred since the coloring of the interference color becomes more concentrated.

The thickness of the continuous film is not particularly limited and may vary depending on the type of metal structuring the film, but a thin film with a thickness of 1 to 20 nm is preferable.

The metal used in the semi-transparent metal coating film is not particularly limited, and can be exemplified by metal elements such as indium (In), aluminum (Al), chromium (Cr), and tin (Sn), and metalloid elements (types of metal elements) such as silicon (Si). In the case of a film with a discontinuous structure, the use of indium, tin, or the like is preferable in terms of ease in forming the film with a discontinuous structure.

The film formation method of the semi-transparent metal coating film is not particularly limited, and can be exemplified by physical deposition such as vacuum deposition, molecular beam deposition, ion plating, ion beam deposition, and sputtering.

### 2. Light Interference Transparent Film

An optical thickness (nd), which is the product of a refractive index (n) and a thickness (d) of the light interference transparent film, is 5 to 150 nm, and preferably 25 to 100 nm.

Light interference caused by the color luminous designed film is the reflection of light between the semi-transparent metal coating film and the ray reflective metal coating film, and varies depending on the light wavelength. Therefore, the refractive index (n) is not particularly limited. However, for light with a wavelength of 550 nm, a refractive index (n) of 1.3 to 2.5 is desirable.

The light interference transparent film is not particularly limited, but preferably includes a surface layer made uneven by morphology control during film formation. Here, the morphology control during film formation refers to increasing an anisotropic growth characteristic of the inorganic compound structuring the film. More specifically, by controlling (reducing and so on) a GR (gas ratio) or the like during film formation, the crystals of the generated inorganic compound are subjected to anisotropic growth. Furthermore, the unevenness caused by the morphology control during film formation refers to an unevenness of the film surface layer generated by the morphology control during such film formation.

The inorganic compound used in the light interference transparent film is not particularly limited, and can be exemplified by an oxide, nitride, oxynitride, sulfide, fluoride, and the like. An oxide or nitride is preferable.

The oxide is not particularly limited, and can be exemplified by metal oxides such as aluminum oxide (Al₂O₃), titanium oxide (TiO₂, etc.), cerium oxide (CeO₂, etc.), zirconium oxide (ZrO₂, etc.), zinc oxide (ZnO), chromium oxide (Cr₂O₃, etc.), tantalum oxide (Ta₂O₅, etc.), and indium oxide (In₂O₃, etc.), and metalloid oxides such as silicon oxide (SiO₂, etc).

The nitride is not particularly limited, and can be exemplified by silicon nitride (Si₃N₄, etc.), aluminum nitride (AlN), titanium nitride (TiN), chromium nitride (CrN), and the like.

The thickness of the light interference transparent film when the above inorganic compounds are used varies depending on the refractive index of the inorganic compound structuring the film. However, in the case of chromium oxide (Cr₂O₃) having a refractive index of 2.5 (at a light wavelength of 550 nm), the thickness is preferably 10 to 45 nm. Meanwhile, in the case of silicon oxide (SiO₂) having a refractive index of 1.46 (at a light wavelength of 550 nm), the thickness is preferably 20 to 80 nm.

The film formation method of the light interference transparent film is not particularly limited, and can be exemplified by physical deposition such as vacuum deposition, molecular beam deposition, ion plating, ion beam deposition, and sputtering, as well as chemical deposition such as thermo chemical deposition, plasma chemical deposition, and photochemical deposition.

### 3. Ray Reflective Metal Coating Film

The ray reflective metal coating film, which is a film formed from a metal and reflects irradiated light, is not particularly limited. However, from the standpoint of obtaining an interference color with high brightness, 30% light reflectance or more in the light wavelength range of the 400 to 800 nm is preferable.

Although the ray reflective metal coating film is not particularly limited, the ray reflective metal coating film may be a film with a discontinuous structure (a sea-island film), in which there are spaces between the metal particles and the structure (the sea-island structure) lacks continuity. Alternatively, the ray reflective metal coating film may be a continuous film, in which there are no spaces between the metal particles and the structure has continuity.

The metal used in the ray reflective metal coating film is not particularly limited, and can be exemplified by metal elements such as indium (In), tin (Sn), aluminum (Al), nickel (Ni), chromium (Cr), and silver (Ag), and metalloid elements (types of metal elements) such as silicon (Si). In the case of a film with a discontinuous structure, the use of indium, tin, or the like is preferable in terms of ease in forming the film with a discontinuous structure.

The film formation method of the ray reflective metal coating film is not particularly limited, and can be exemplified by physical deposition such as vacuum deposition, molecular beam deposition, ion plating, ion beam deposition, and sputtering.

### 4. Second Transparent Film

The inorganic compound used in the second transparent film is not particularly limited, and the inorganic compounds mentioned in the section on the light interference transparent film above maybe used. In addition, the inorganic compound used in the second transparent film may be identical to or different from the inorganic compound used in the light interference transparent film structuring the color luminous designed film, which is provided with the second transparent film.

### 5. Other Films

Under the ray reflective metal coating film, the color luminous designed film may or may not have an anti-corrosion protective film that improves the corrosion resistance (oxidation resistance) of the ray reflective metal coating film.

### 6. Color Luminous Designed Film

The manner in which the color luminous designed film is provided is not particularly limited. The color luminous designed film may color the apparatus decoration or the like by being provided on at least a portion of the surface of the apparatus decoration (including a surface that appears by unlidding a portion of the apparatus decoration or the like) or the like. Also, the color luminous designed film may color the apparatus decoration or the like by being provided in an internal portion visible from outside the apparatus decoration or the like.

### 7. Surface Layer

The transparent material forming the surface layer is not particularly limited, and can be exemplified by polycarbonate resin (PC), acrylic resin (acrylic), glass, and so on.

### 8. Apparatus Housing and Apparatus Decoration

The apparatus is not particularly limited, and can be exemplified by a transport apparatus such as an automobile or the like, telecommunication equipment such as a mobile phone or the like, and electrical equipment such as a television or the like. The apparatus housing is not particularly limited, and can be exemplified by a housing for a mobile phone, and a housing for a television, and so on. The apparatus decoration is not particularly limited, and can be exemplified by an automotive decorative product, such as a radiator grille, grille cover, side molding, back panel, bumper, emblem, steering wheel, instrument panel, and so on.

According to the present invention, it is possible to provide an apparatus housing and an apparatus decoration that are colored by an interference color film (a color luminous designed film), which hardly generates color changes (rainbow coloring) caused by a change in a view direction (angle) or by different thicknesses of interference color films (particularly light interference transparent films) resulting from a shape or the like of a colored object.

### BRIEF DESCRIPTION OF THE DRAWINGS

FIG. 1 is a schematic diagram of the detail of a grille cover of an embodiment according to the present invention;

FIGS. 2A and 2B are conceptual drawings of coloring by a color luminous designed film;

FIGS. 3A and 3B are conceptual drawings of differences in interference light due to different color luminous designed films;

FIGS. 4A and 4B are conceptual drawings of differences in interference light due to different color luminous designed films;

FIG. 5 is a graph showing the relationship between a thickness of a metal coating film and reflectance;

FIG. 6 is a graph showing the relationship between the thickness of the metal coating film and transmittance;

FIG. 7 is a graph showing the relationship between a light wavelength and reflectance;

FIG. 8 is a micrograph of the detail of a Comparative Example 25;

FIG. 9 is a micrograph of the detail of a Comparative Example 8; and

FIG. 10 is a micrograph of the detail of a chromium oxide film.

### DETAILED DESCRIPTION OF THE PREFERRED EMBODIMENTS

An apparatus housing and an apparatus decoration are colored by a color luminous designed film, wherein the color luminous designed film includes a semi-transparent metal coating film, a light interference transparent film under the semi-transparent metal coating film, and a ray reflective metal coating film under the light interference transparent film. The light interference transparent film has an optical thickness of 5 to 150 nm and is formed from an inorganic compound. The apparatus housing and the apparatus decoration also include a surface layer formed from a transparent resin or glass on the color luminous designed film.

### EXAMPLES

Before describing specific examples and so forth, the coloring principle of the color luminous designed film (the interference color film) used in the present invention will be explained.

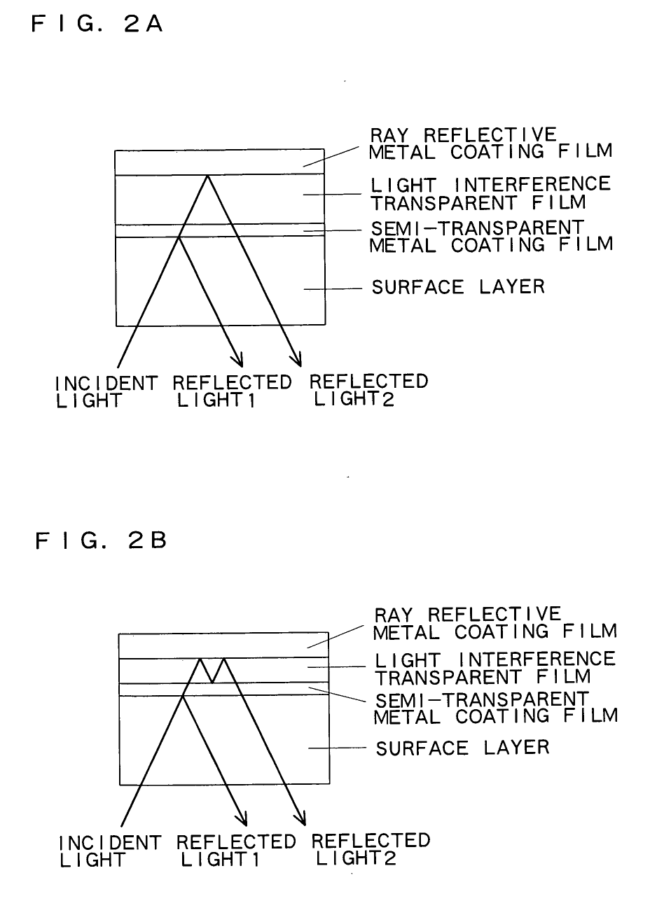

As illustrated in FIGS. 2A and 2B, using the Fabry-Perot interference optical system, reflected light 1 and reflected light 2 interfere and generate color due to an optical path difference between metal layers (between a semi-transparent metal coating film and a ray reflective metal coating film) in the color luminous designed film used in the present invention. Note that interference occurs regardless of the refractive index of a substrate (a surface layer).

Regarding the brightness of the interference color and the like, higher light reflectance of the semi-transparent metal coating film increases brightness. In addition, higher light transmittance of the semi-transparent metal coating film strengthens the interference color, and higher light reflectance of the ray reflective metal coating film both increases brightness and strengthens the interference color.

As FIG. 2B shows, the optical path difference between the metal layers (between the semi-transparent metal coating film and the ray reflective metal coating film) can be gained by the use of multiple reflection (multiple interference), wherein the reflected light of the ray reflective metal coating film is reflected by the semi-transparent metal coating film. Therefore, the light interference transparent film can be made thinner. Compared to the single reflection shown in FIG. 2A, multiple reflection has lower light reflectance overall, which thus lowers the brightness of the interference color.

Next, the light reflectance and transmittance characteristics depending on the thicknesses of the metal coating films (the semi-transparent metal coating film and the ray reflective metal coating film) were measured as follows.

Measurement samples were created by depositing indium (In) or aluminum (Al) by evaporation on a substrate formed from polycarbonate resin or glass so as to have a desired thickness.

It should be noted that the polycarbonate resin substrate and the glass substrate used for the respective measurement samples both exhibited approximately 9% light reflectance.

a) For the light reflectance characteristic, each measurement sample was measured at a 5° incident angle using an ultraviolet-visible spectrophotometer (made by Shimadzu Corporation) equipped with a specular reflection measurement device. Note that an aluminum standard sample was used as a reference.

b) For the light transmittance characteristic, each measurement sample was measured using the ultraviolet-visible spectrophotometer (made by Shimadzu Corporation).

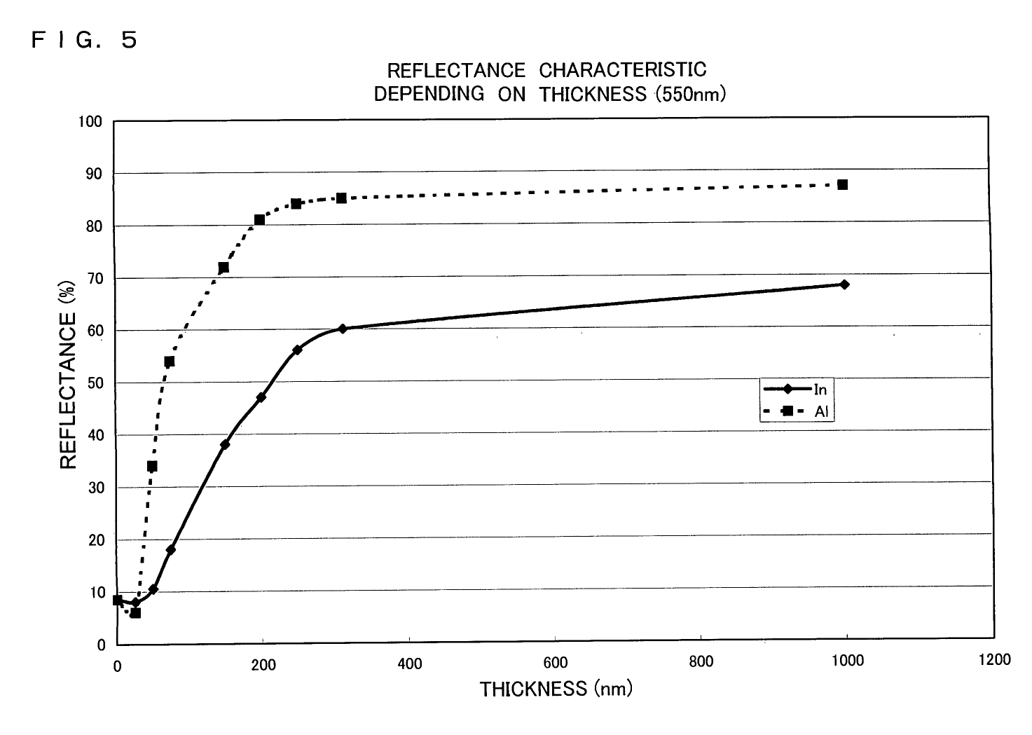

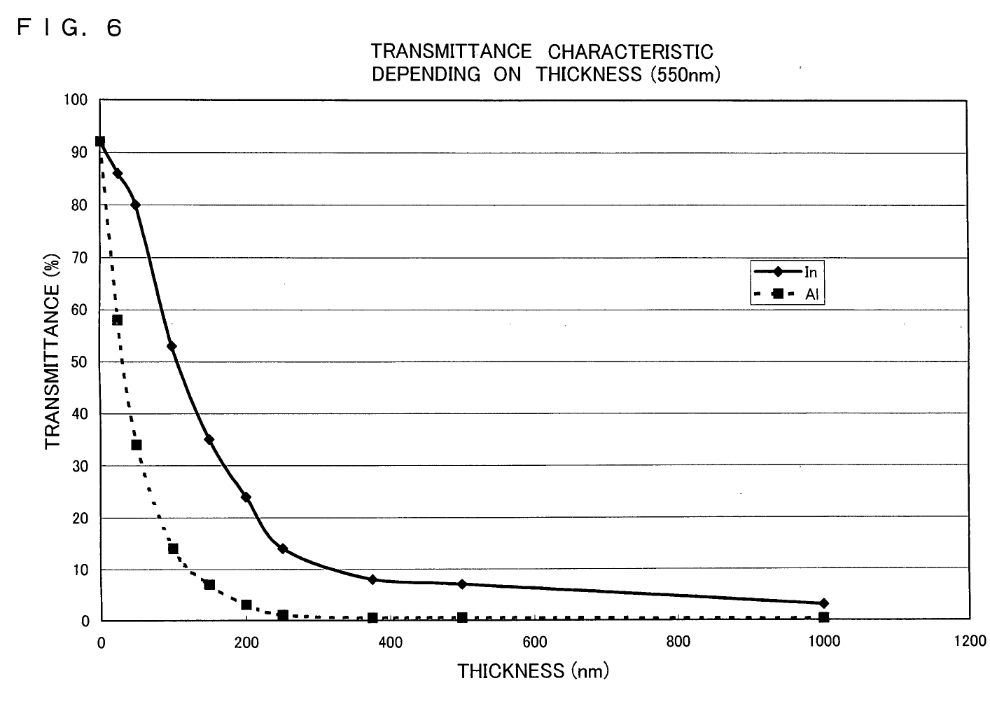

The measurement results for the reflectance characteristic and the transmittance characteristic are shown in FIGS. 5 and 6, respectively. The light reflectance (9%) of the substrate is also included.

The light reflectance and light transmittance of the semi-transparent metal coating film and the ray reflective metal coating film of examples and comparative examples described later were found using these measurement results (graphs).

As indicated in FIGS. 5 and 6, an increased thickness of the metal coating films is accompanied by higher light reflectance and lower light transmittance.

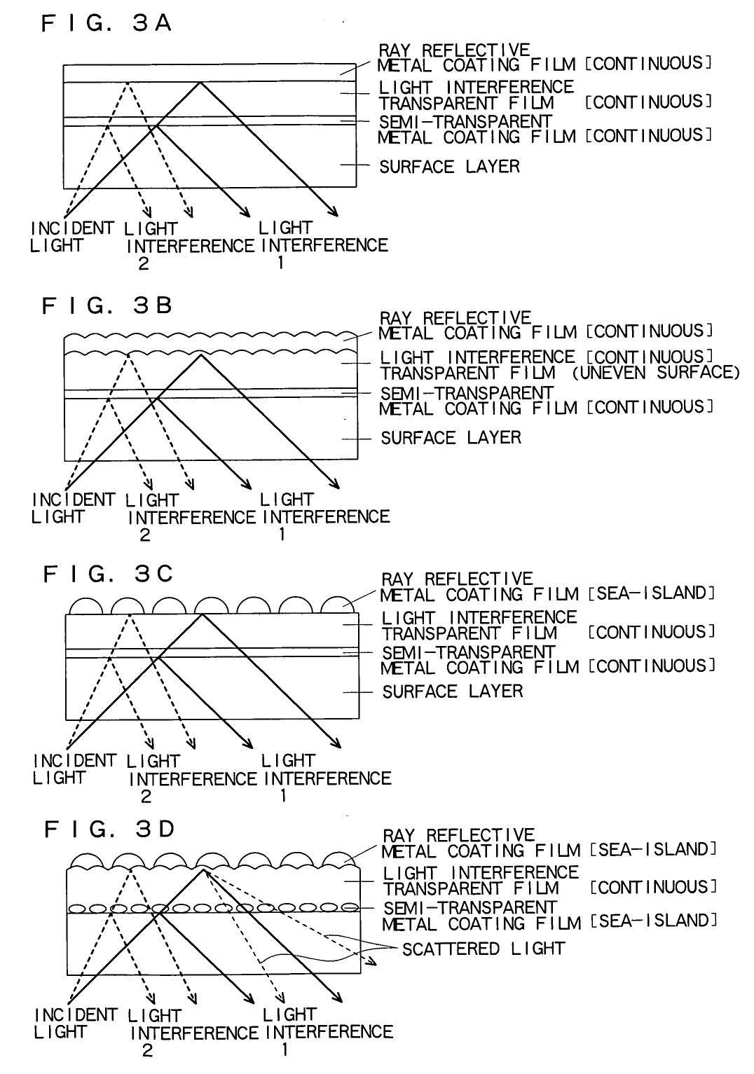

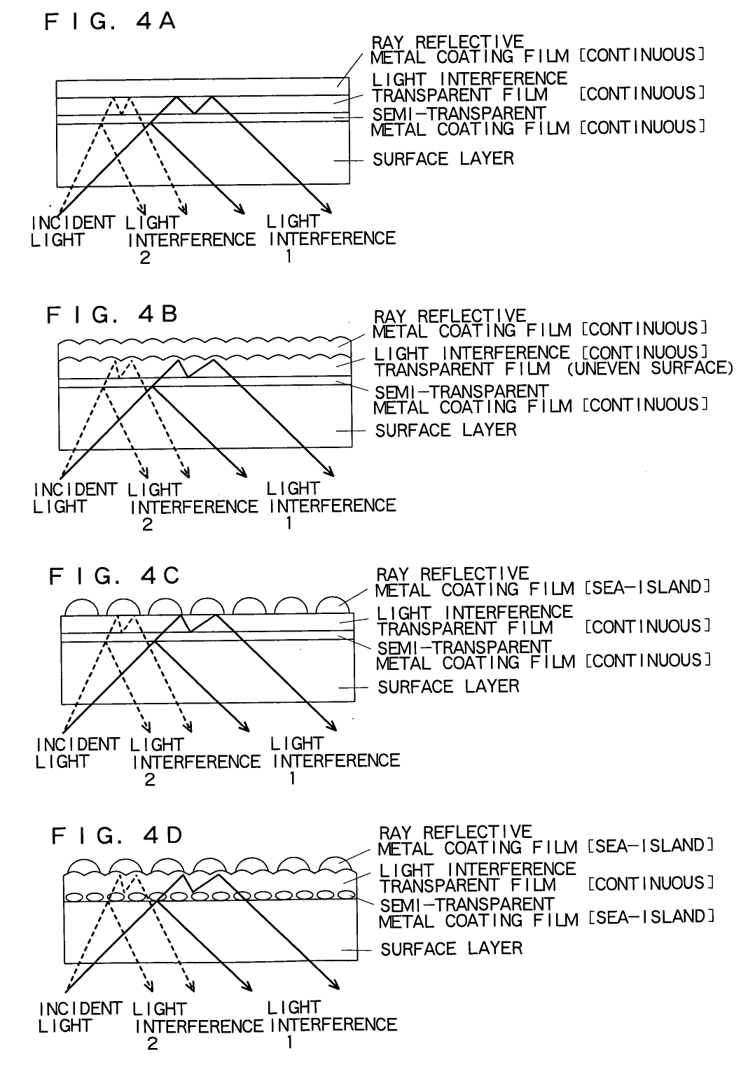

Table 1 shows the influences (differences) on the coloring and the like of the color luminous designed film depending on the different forms of the light interference transparent film, the semi-transparent metal coating film, and the ray reflective metal coating film. In addition, FIGS. 3 and 4 illustrate respective conceptual drawings therefor. Note that for the light interference transparent film with a continuous film (thick), an optical thickness (nd) is thick and one-half the wavelength of visible light (a thickness of 60 nm or more for chromium oxide). Meanwhile, for the light interference transparent film with a continuous film (thin), the optical thickness (nd) is thin and one-fourth the wavelength of visible light (a thickness of 60 nm or less for chromium oxide). The light interference transparent films of sample Nos. 2 and 6 are continuous films whose surfaces have been made uneven by morphology control.

TABLE 1

| | | Sample No. | | | | | | | |
|---|---|---|---|---|---|---|---|---|---|
| | | 1 | 2 | 3 | 4 | 5 | 6 | 7 | 8 |
| Film Type | Semi-transparent | Continuous | Continuous | Continuous | Sea-island | Continuous | Continuous | Continuous | Sea-island |
| | metal coating film | film | film | film | film | film | film | film | film |
| | Light | Continuous | Continuous | Continuous | Continuous | Continuous | Continuous | Continuous | Continuous |
| | interference | film | film | film | film | film | film | film (thin) | film (thin) |
| | transparent film | (thick) | (thick) | (thick) | (thick) | (thin) | (thin) | | |
| | Ray reflective | Continuous | Continuous | Sea-island | Sea-island | Continuous | Continuous | Sea-island | Sea-island |
| | metal coating film | film | film | film | film | film | film | film | film |
| | Corresponding | 3-a | 3-b | 3-c | 3-d | 4-a | 4-b | 4-c | 4-d |
| | conceptual | | | | | | | | |
| | drawing | | | | | | | | |
| Physical | Light path length | None | Small | Medium | Medium | Small | Medium | Large | Large |
| Phenomenon | variations | | | | | | | | |
| | within | | | | | | | | |
| | light | | | | | | | | |
| | interference | | | | | | | | |
| | transparent film | | | | | | | | |
| | Interference | Narrow | Slightly | Medium | Medium | Slightly | Medium | Wide | Wide |
| | waveform | | narrow | | | narrow | | | |
| | (Half width of | | | | | | | | |
| | spectral | | | | | | | | |
| | waveform) | | | | | | | | |
| | Light Scattering | None | Small | Large | Large | None | Small | Large | Large |
| Design | Coloring | Large | Large | Medium | Medium | Large | Medium | Small | Small to |
| | dependency | | | | | | | | none |
| | on thickness | | | | | | | | |
| | Coloring | Large | Large | Medium | Medium | Medium | Small | Minimal | Minimal |
| | Dependency | | | | | | | | |
| | on view angle | | | | | | | | |
| | Color tone | Sharp | Sharp | Medium | Dull | Sharp | Sharp | Medium | Dull |

The coloring dependency on thickness is a property where the coloring changes (rainbow coloring occurs) due to non-uniform thicknesses (a thickness distribution when the film is formed according to a product shape), and the coloring dependency on the view angle is a property where the coloring changes (rainbow coloring occurs) due to changes in the view angle. According to Table 1, such dependencies can be reduced in the color luminous designed film by the following: reducing the optical thickness of the light interference transparent film; making the surface of the light interference transparent film uneven; using a sea-island film that has a sea-island structure (a film with a discontinuous structure) for the semi-transparent metal coating film; or using a sea-island film that has a sea-island structure (a film with a discontinuous structure) for the ray reflective metal coating film. Furthermore, this also gave the color tone of the interference color film a dull hue.

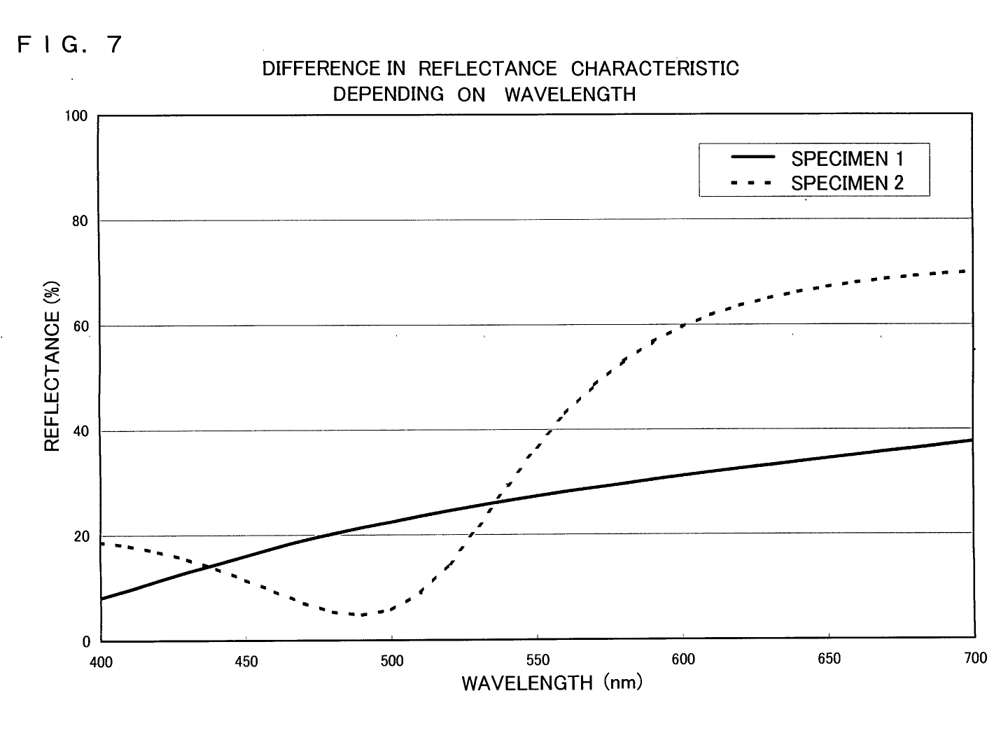

Next, light reflectance in the visible light range depending on different thicknesses (optical thicknesses) of the light interference transparent film was measured in the two types of specimens shown below. The results are shown in FIG. 7.
Specimen 1: a film formed by laminating a semi-transparent metal coating film (material: In, thickness: 10 nm), a light interference transparent film (material: CrOₓ, thickness: 30 nm), and a ray reflective metal coating film (material: In, thickness: 30 nm) in serial order on a transparent surface layer. Note that CrOₓ is a chromium oxide.
Specimen 2: a film identical to Specimen 1, except for the use of a different light interference transparent film (material: SiO₂, thickness: 140 nm).

Based on the measurement results, when the thickness (optical thickness) of the light interference transparent film is thin as in Specimen 1, a line indicating the relationship between the light wavelength and light reflectance is broad. In other words, changes in reflectance caused by different light wavelengths are reduced. Accordingly, the coloring of the color luminous designed film has less dependence on the thickness and view angle. Furthermore, in such case, if the thickness (optical thickness) of the light interference transparent film is set such that the wavelength indicating the reflectance peak (a wavelength with a local maximum or minimum value) falls outside the visible light range, the spectral characteristic (the relationship between the wavelength and reflectance) of the visible light range will continue to increase without change. This is true regardless of whether the length of the optical path which light passes through the light interference transparent film changes due to a change in the light incident angle or the like, and regardless of whether the light wavelength generating interference changes.

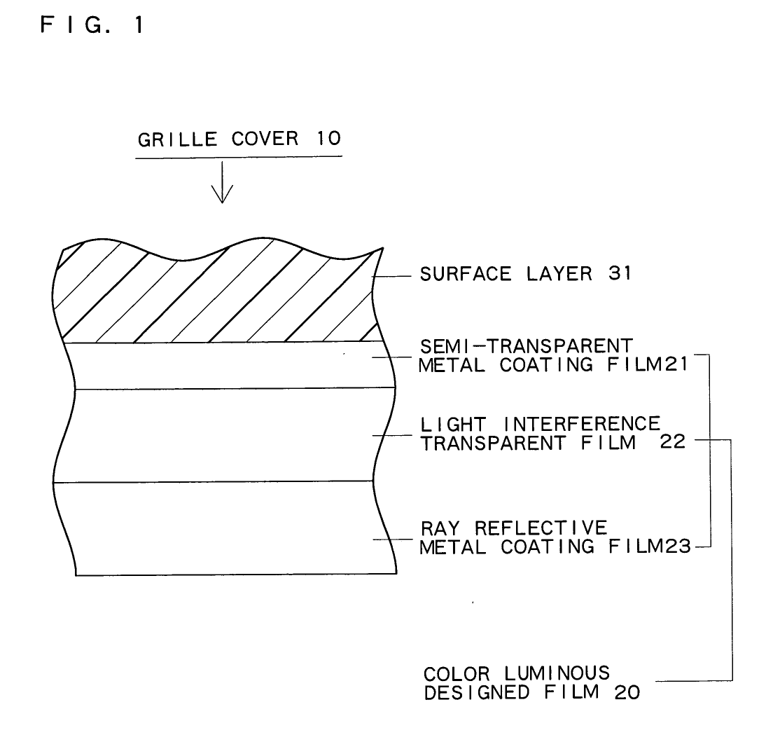

A grille cover 10 illustrated in FIG. 1 is an automotive decorative product of an embodiment according to the present invention. As shown in FIG. 1, the grille cover 10 is provided with a surface layer 31, which is formed from transparent polycarbonate resin (PC) so that an interference color is externally visible. The grille cover 10 is colored by a color luminous designed film 20 underneath the surface layer 31. The color luminous designed film 20 is formed by vacuum-depositing a semi-transparent metal coating film 21 formed from indium (In), a light interference transparent film 22 formed from chromium oxide (Cr₂O₃), and a ray reflective metal coating film 23 formed from indium (In) in the order listed here.

Examples of the present invention with 79 different structures were measured and evaluated in terms of appearance and electromagnetic permeability, as shown in Tables 2 and 3. Comparative examples with 29 different structures were also measured and evaluated in terms of appearance and electromagnetic permeability. Tables 2 and 3 summarize the structures and evaluation results of the examples and comparative examples.

TABLE 2

| | Structure | | | | | | | | | | |
|---|---|---|---|---|---|---|---|---|---|---|---|
| | | Semi-transparent metal | | | | | | | | | |
| | | coating film | | | | | Light interference | | | | |
| | | | | Light | | | transparent film | | | | |
| | Surface | | | trans- | Light | Thick- | | | Thick- | Optical | |
| | layer | Ma- | | mittance | reflectance | ness | | Refractive | ness | thickness | Morphology |
| | Material | terial | Structure | (%) | (%) | (nm) | Material | index | (nm) | (nm) | control |
| Comparative | PC | None | — | 92 | — | 0 | Cr₂O₃ | 2.5 | 80 | 200.0 | Yes |
| Example 1 | | | | | | | | | | | |
| Comparative | PC | In | Sea-island | 80 | — | 2.5 | Cr₂O₃ | 2.5 | 80 | 200.0 | Yes |
| Example 2 | | | | | | | | | | | |
| Comparative | PC | In | Sea-island | 55 | — | 10 | Cr₂O₃ | 2.5 | 80 | 200.0 | Yes |
| Example 3 | | | | | | | | | | | |
| Comparative | PC | In | Sea-island | 25 | — | 20 | Cr₂O₃ | 2.5 | 80 | 200.0 | Yes |
| Example 4 | | | | | | | | | | | |
| Comparative | PC | In | Sea-island | 8 | — | 40 | Cr₂O₃ | 2.5 | 80 | 200.0 | Yes |
| Example 5 | | | | | | | | | | | |
| Example 1 | PC | In | Sea-island | 65 | 12 | 8 | Cr₂O₃ | 2.5 | 29.8 | 74.5 | Yes |
| Example 2 | PC | In | Sea-island | 63 | 18 | 9 | Cr₂O₃ | 2.5 | 24.1 | 60.3 | Yes |
| Example 3 | PC | In | Sea-island | 55 | 19 | 9.9 | Cr₂O₃ | 2.5 | 39.4 | 98.5 | Yes |
| Example 4 | PC | In | Sea-island | 55 | 19 | 9.9 | Cr₂O₃ | 2.5 | 27.5 | 68.8 | Yes |
| Example 5 | PC | In | Sea-island | 32 | 30 | 14.4 | Cr₂O₃ | 2.5 | 33 | 82.5 | Yes |
| Example 6 | PC | In | Sea-island | 33 | 35 | 15 | Cr₂O₃ | 2.5 | 25 | 62.5 | Yes |
| Example 7 | PC | In | Sea-island | 82 | — | 5 | Cr₂O₃ | 2.5 | 10 | 25.0 | Yes |
| Example 8 | PC | In | Sea-island | 82 | — | 5 | Cr₂O₃ | 2.5 | 10 | 25.0 | Yes |
| Example 9 | PC | In | Sea-island | 82 | — | 5 | Cr₂O₃ | 2.5 | 15 | 37.5 | Yes |
| Example 10 | PC | In | Sea-island | 82 | — | 5 | Cr₂O₃ | 2.5 | 15 | 37.5 | Yes |
| Example 11 | PC | In | Sea-island | 55 | — | 10 | Cr₂O₃ | 2.5 | 20 | 50.0 | Yes |
| Example 12 | PC | In | Sea-island | 82 | — | 5 | Cr₂O₃ | 2.5 | 20 | 50.0 | Yes |
| Example 13 | PC | In | Sea-island | 82 | — | 5 | Cr₂O₃ | 2.5 | 20 | 50.0 | Yes |
| Example 14 | PC | In | Sea-island | 82 | — | 5 | Cr₂O₃ | 2.5 | 30 | 75.0 | Yes |
| Example 15 | PC | In | Sea-island | 55 | — | 10 | Cr₂O₃ | 2.5 | 35 | 87.5 | Yes |
| Comparative | PC | In | Sea-island | 55 | — | 10 | Cr₂O₃ | 2.5 | 65 | 162.5 | Yes |
| Example 6 | | | | | | | | | | | |
| Comparative | PC | In | Sea-island | 55 | — | 10 | Cr₂O₃ | 2.5 | 72.5 | 181.3 | Yes |
| Example 7 | | | | | | | | | | | |
| Comparative | PC | In | Sea-island | 55 | — | 10 | Cr₂O₃ | 2.5 | 80 | 200.0 | Yes |
| Example 8 | | | | | | | | | | | |
| Comparative | PC | In | Sea-island | 55 | — | 10 | Cr₂O₃ | 2.5 | 95 | 237.5 | Yes |
| Example 9 | | | | | | | | | | | |
| Comparative | PC | In | Sea-island | 55 | — | 10 | Cr₂O₃ | 2.5 | 110 | 275.0 | Yes |
| Example 10 | | | | | | | | | | | |
| Comparative | PC | In | Sea-island | 55 | — | 10 | Cr₂O₃ | 2.5 | 125 | 312.5 | Yes |
| Example 11 | | | | | | | | | | | |
| Comparative | PC | In | Sea-island | 55 | — | 10 | Cr₂O₃ | 2.5 | 140 | 350.0 | Yes |
| Example 12 | | | | | | | | | | | |
| Comparative | PC | In | Sea-island | 55 | — | 10 | Cr₂O₃ | 2.5 | 300 | 750.0 | Yes |
| Example 13 | | | | | | | | | | | |
| Comparative | PC | In | Sea-island | 55 | — | 10 | Cr₂O₃ | 2.5 | 500 | 1250.0 | Yes |
| Example 14 | | | | | | | | | | | |
| Comparative | PC | In | Sea-island | 55 | — | 10 | Cr₂O₃ | 2.5 | 80 | 200.0 | Yes |
| Example 15 | | | | | | | | | | | |
| Comparative | PC | In | Sea-island | 55 | — | 10 | Cr₂O₃ | 2.5 | 80 | 200.0 | Yes |
| Example 16 | | | | | | | | | | | |
| Comparative | PC | In | Sea-island | 55 | — | 10 | Cr₂O₃ | 2.5 | 80 | 200.0 | Yes |
| Example 17 | | | | | | | | | | | |
| Comparative | PC | In | Sea-island | 55 | — | 10 | Cr₂O₃ | 2.5 | 80 | 200.0 | Yes |
| Example 18 | | | | | | | | | | | |
| Comparative | PC | In | Sea-island | 55 | — | 10 | Cr₂O₃ | 2.5 | 80 | 200.0 | Yes |
| Example 19 | | | | | | | | | | | |
| Comparative | PC | In | Sea-island | 55 | — | 10 | Cr₂O₃ | 2.5 | 80 | 200.0 | Yes |
| Example 20 | | | | | | | | | | | |
| Comparative | PC | None | — | — | — | 0 | Cr₂O₃ | 2.5 | 80 | 200.0 | No |
| Example 21 | | | | | | | | | | | |
| Comparative | PC | Al | Continuous | 60 | 12 | 2.5 | Cr₂O₃ | 2.5 | 80 | 200.0 | No |
| Example 22 | | | | | | | | | | | |
| Comparative | PC | Al | Continuous | 40 | 18 | 4 | Cr₂O₃ | 2.5 | 80 | 200.0 | No |
| Example 23 | | | | | | | | | | | |
| Comparative | PC | Al | Continuous | 35 | 35 | 4.8 | Cr₂O₃ | 2.5 | 80 | 200.0 | No |
| Example 24 | | | | | | | | | | | |
| Comparative | PC | Al | Continuous | 13 | 53 | 10 | Cr₂O₃ | 2.5 | 80 | 200.0 | No |
| Example 25 | | | | | | | | | | | |
| Example 16 | PC | Al | Continuous | 60 | 12 | 2.5 | Cr₂O₃ | 2.5 | 30 | 75.0 | No |
| Example 17 | PC | Al | Continuous | 50 | 29 | 3.4 | Cr₂O₃ | 2.5 | 30 | 75.0 | No |
| Example 18 | PC | Al | Continuous | 30 | 40 | 5.5 | Cr₂O₃ | 2.5 | 30 | 75.0 | Yes |
| Example 19 | PC | In | Sea-island | 65 | 12 | 8 | Cr₂O₃ | 2.5 | 30 | 75.0 | Yes |
| Comparative | PC | None | — | — | — | 0 | Cr₂O₃ | 2.5 | 80 | 200.0 | No |
| Example 26 | | | | | | | | | | | |
| Example 20 | PC | Al | Continuous | 60 | 12 | 2.5 | Cr₂O₃ | 2.5 | 30 | 75.0 | No |
| Example 21 | PC | Al | Continuous | 40 | 18 | 4 | Cr₂O₃ | 2.5 | 30 | 75.0 | No |
| Example 22 | PC | Al | Continuous | 30 | 30 | 5.5 | Cr₂O₃ | 2.5 | 30 | 75.0 | No |
| Example 23 | PC | Cr | Continuous | 70 | — | 2.5 | Cr₂O₃ | 2.5 | 30 | 75.0 | Yes |
| Example 24 | PC | Cr | Continuous | 60 | 12 | 4 | Cr₂O₃ | 2.5 | 30 | 75.0 | Yes |
| Example 25 | PC | Cr | Continuous | 50 | — | 5 | Cr₂O₃ | 2.5 | 20 | 50.0 | Yes |
| Example 26 | PC | Cr | Continuous | 40 | 19 | 8.8 | Cr₂O₃ | 2.5 | 30 | 75.0 | Yes |
| Example 27 | PC | Sn | Sea-island | 35 | 18 | 13.9 | Cr₂O₃ | 2.5 | 30 | 75.0 | Yes |
| Example 28 | PC | Cr | Continuous | 40 | 18 | 8.5 | Cr₂O₃ | 2.5 | 30 | 75.0 | Yes |

| | Structure | | | | Evaluation | | | | |
|---|---|---|---|---|---|---|---|---|---|
| | Ray reflective metal | | | | Appearance | | | Electro- | |
| | coating film | | | | | | Coloring | magnetic | |
| | | | Light | | | | dependency on | Permeability | |
| | Material | Structure | reflectance (%) | Thickness (nm) | Coloring | Brightness | the view angle | 2 GHz | 76 GHz |
| Comparative | In | Sea-island | 56 | 25 | Dark | None | Yes | ◯ | ◯ |
| Example 1 | | | | | yellow | | | | |
| Comparative | In | Sea-island | 56 | 25 | Yellow | Low | Yes | ◯ | ◯ |
| Example 2 | | | | | | | | | |
| Comparative | In | Sea-island | 56 | 25 | Yellow | Medium | Yes | ◯ | ◯ |
| Example 3 | | | | | | | | | |
| Comparative | In | Sea-island | 56 | 25 | Yellow | High | Yes | ◯ | ◯ |
| Example 4 | | | | | | | | | |
| Comparative | In | Sea-island | 56 | 25 | Light red | High | Yes | ◯ | ◯ |
| Example 5 | | | | | | | | | |
| Example 1 | In | Sea-island | 63 | 50 | Dark blue | Low | No | ◯ | ◯ |
| Example 2 | In | Sea-island | 63 | 50 | Blue | Medium | No | ◯ | ◯ |
| Example 3 | In | Sea-island | 63 | 50 | Light | Medium | No | ◯ | ◯ |
| | | | | | blue | | | | |
| Example 4 | In | Sea-island | 63 | 50 | Blue | Medium | No | ◯ | ◯ |
| Example 5 | In | Sea-island | 63 | 50 | Light | High | No | ◯ | ◯ |
| | | | | | blue | | | | |
| Example 6 | In | Sea-island | 60 | 40 | Very | High | No | ◯ | ◯ |
| | | | | | light | | | | |
| | | | | | blue | | | | |
| Example 7 | In | Sea-island | 57 | 35 | Indigo | Medium | No | ◯ | ◯ |
| Example 8 | In | Sea-island | 63 | 45 | Purple | Medium | No | ◯ | ◯ |
| Example 9 | In | Sea-island | 57 | 35 | Blue | Medium | No | ◯ | ◯ |
| Example 10 | In | Sea-island | 63 | 45 | Blue | Medium | No | ◯ | ◯ |
| Example 11 | In | Sea-island | 60 | 40 | Blue | Medium | No | ◯ | ◯ |
| Example 12 | In | Sea-island | 57 | 35 | Blue | Medium | No | ◯ | ◯ |
| Example 13 | In | Sea-island | 63 | 45 | Purple | Medium | No | ◯ | ◯ |
| Example 14 | In | Sea-island | 63 | 45 | Green | Medium | No | ◯ | ◯ |
| | | | | | blue | | | | |
| Example 15 | In | Sea-island | 60 | 40 | Blue | Medium | No | ◯ | ◯ |
| Comparative | In | Sea-island | 60 | 40 | None | High | — | ◯ | ◯ |
| Example 6 | | | | | (Silver) | | | | |
| Comparative | In | Sea-island | 60 | 40 | Light | High | Yes | ◯ | ◯ |
| Example 7 | | | | | yellow | | | | |
| Comparative | In | Sea-island | 60 | 40 | Yellow | Medium | Yes | ◯ | ◯ |
| Example 8 | | | | | | | | | |
| Comparative | In | Sea-island | 60 | 40 | Orange | Medium | Yes | ◯ | ◯ |
| Example 9 | | | | | | | | | |
| Comparative | In | Sea-island | 60 | 40 | Purple | Medium | Yes | ◯ | ◯ |
| Example 10 | | | | | | | | | |
| Comparative | In | Sea-island | 60 | 40 | Blue | Medium | Yes | ◯ | ◯ |
| Example 11 | | | | | | | | | |
| Comparative | In | Sea-island | 60 | 40 | Blue | Medium | Yes | ◯ | ◯ |
| Example 12 | | | | | | | | | |
| Comparative | In | Sea-island | 60 | 40 | Purple | Medium | Yes | ◯ | ◯ |
| Example 13 | | | | | (slightly | | | | |
| | | | | | cloudy) | | | | |
| Comparative | In | Sea-island | 60 | 40 | Blue | Low | Yes | ◯ | ◯ |
| Example 14 | | | | | (very | | | | |
| | | | | | cloudy) | | | | |
| Comparative | In | Sea-island | — | 0 | Blue | Low | Yes | ◯ | ◯ |
| Example 15 | | | | | | | | | |
| Comparative | In | Sea-island | 8 | 2.5 | Blue | Low | Yes | ◯ | ◯ |
| Example 16 | | | | | | | | | |
| Comparative | In | Sea-island | 25 | 10 | Blue | Low | Yes | ◯ | ◯ |
| Example 17 | | | | | | | | | |
| Comparative | In | Sea-island | 45 | 20 | Yellow | Medium | Yes | ◯ | ◯ |
| Example 18 | | | | | | | | | |
| Comparative | In | Sea-island | 60 | 40 | Yellow | Medium | Yes | ◯ | ◯ |
| Example 19 | | | | | | | | | |
| Comparative | In | Sea-island | 65 | 150 | Yellow | High | Yes | X | X |
| Example 20 | | | | | | | | | |
| Comparative | Al | Continuous | 80 | 25 | Indigo | High | Yes | X | X |
| Example 21 | | | | | | | | | |
| Comparative | Al | Continuous | 80 | 25 | Yellow | High | Yes | X | X |
| Example 22 | | | | | | | | | |
| Comparative | Al | Continuous | 80 | 25 | Yellow | High | Yes | X | X |
| Example 23 | | | | | | | | | |
| Comparative | Al | Continuous | 80 | 25 | Yellow | High | Yes | X | X |
| Example 24 | | | | | Orange | | | | |
| Comparative | Al | Continuous | 80 | 25 | Yellow | High | Yes | X | X |
| Example 25 | | | | | | | | | |
| Example 16 | Al | Continuous | 81 | 30 | Yellow | Slightly | Little | X | X |
| | | | | | | High | | | |
| Example 17 | Al | Continuous | 81 | 30 | Yellow | High | Little | X | X |
| Example 18 | Al | Continuous | 81 | 30 | Light | High | No | X | X |
| | | | | | yellow | | | | |
| Example 19 | Al | Continuous | 85 | 80 | Purple | Medium | No | X | X |
| Comparative | Al | Continuous | 80 | 25 | Indigo | High | Yes | X | X |
| Example 26 | | | | | | | | | |
| Example 20 | In | Sea-island | 57 | 30 | Yellow | Medium | No | ◯ | ◯ |
| Example 21 | In | Sea-island | 57 | 30 | Yellow | Medium | No | X | X |
| Example 22 | In | Sea-island | 57 | 30 | Yellow | High | No | X | X |
| Example 23 | Sn | Sea-island | 55 | 30 | Red | Low | No | ◯ | ◯ |
| Example 24 | Sn | Sea-island | 55 | 30 | Red | Low | No | X | X |
| Example 25 | In | Sea-island | 63 | 45 | Orange | Medium | No | ◯ | ◯ |
| Example 26 | Al | Continuous | 81 | 30 | Blue | Medium | No | X | X |
| | | | | | green | | | | |
| Example 27 | Sn | Sea-island | 55 | 30 | Blue | Medium | No | ◯ | ◯ |
| Example 28 | Cr | Continuous | 45 | 30 | Blue | Low | No | X | X |

TABLE 3

| | Structure | | | | | | | | | | |
|---|---|---|---|---|---|---|---|---|---|---|---|
| | | Semi-transparent metal | | | | | | | | | |
| | | coating film | | | | | Light interference | | | | |
| | | | | Light | | | transparent film | | | | |
| | Surface | | | trans- | Light | Thick- | | | Thick- | Optical | |
| | layer | Ma- | | mittance | reflectance | ness | | Refractive | ness | thickness | Morphology |
| | Material | terial | Structure | (%) | (%) | (nm) | Material | index | (nm) | (nm) | control |
| Example 29 | PC | Si | Continuous | 40 | — | 20 | SiO₂ | 1.46 | 20 | 29.2 | Yes |
| Example 30 | PC | Cr | Continuous | 80 | — | 6 | SiO₂ | 1.46 | 20 | 29.2 | No |
| Example 31 | PC | Cr | Continuous | 84 | — | 5 | SiO₂ | 1.46 | 20 | 29.2 | No |
| Example 32 | PC | In | Sea-island | 82 | 18 | 5 | SiO₂ | 1.46 | 20 | 29.2 | Yes |
| Example 33 | PC | In | Sea-island | 55 | 18 | 9.5 | TiO₂ | 2.35 | 30 | 70.5 | Yes |
| Comparative | PC | In | Sea-island | 55 | 18 | 9.5 | TiO₂ | 2.35 | 117 | 275.0 | Yes |
| Example 27 | | | | | | | | | | | |
| Example 34 | PC | In | Sea-island | 55 | 18 | 9.5 | Al₂O₃ | 1.63 | 30 | 48.9 | Yes |
| Example 35 | PC | In | Sea-island | 55 | 18 | 9.5 | Ta₂O₅ | 2.1 | 30 | 63.0 | Yes |
| Example 36 | PC | In | Sea-island | 55 | 18 | 9.5 | Ta₂O₅ | 2.1 | 30 | 63.0 | Yes |
| Example 37 | PC | In | Sea-island | 55 | 18 | 9.5 | SiO₂ | 1.46 | 30 | 43.8 | Yes |
| Example 38 | PC | In | Sea-island | 55 | 18 | 9.5 | SiN | 2.0 | 30 | 60.0 | Yes |
| Example 39 | Acrylic | In | Sea-island | 55 | — | 10 | Cr₂O₃ | 2.5 | 25 | 62.5 | Yes |
| Example 40 | Acrylic | In | Sea-island | 55 | — | 10 | Cr₂O₃ | 2.5 | 30 | 75.0 | Yes |
| Example 41 | Acrylic | In | Sea-island | 55 | — | 10 | Cr₂O₃ | 2.5 | 35 | 87.5 | Yes |
| Example 42 | Glass | In | Sea-island | 55 | 25.8 | 10.2 | Cr₂O₃ | 2.5 | 8.6 | 21.5 | Yes |
| Example 43 | Glass | In | Sea-island | 55 | 25.4 | 10.2 | Cr₂O₃ | 2.5 | 17.1 | 42.8 | Yes |
| Example 44 | Glass | In | Sea-island | 55 | 24.1 | 10.2 | Cr₂O₃ | 2.5 | 25.4 | 63.5 | Yes |
| Example 45 | Glass | In | Sea-island | 55 | 22.6 | 10.3 | Cr₂O₃ | 2.5 | 33.6 | 84.0 | Yes |
| Example 46 | Glass | In | Sea-island | 55 | 24.2 | 10.3 | Cr₂O₃ | 2.5 | 41.7 | 104.3 | Yes |
| Example 47 | Glass | In | Sea-island | 55 | 25.6 | 10.3 | Cr₂O₃ | 2.5 | 49.7 | 124.3 | Yes |
| Example 48 | Glass | In | Sea-island | 55 | 29.1 | 10.3 | SiO₂ | 1.46 | 11.1 | 16.2 | Yes |
| Example 49 | Glass | In | Sea-island | 55 | 28.5 | 10.3 | SiO₂ | 1.46 | 21.3 | 31.1 | Yes |
| Example 50 | Glass | In | Sea-island | 55 | 27.4 | 10.3 | SiO₂ | 1.46 | 31.4 | 45.8 | Yes |
| Example 51 | Glass | In | Sea-island | 55 | 31.4 | 10.3 | SiO₂ | 1.46 | 46.2 | 67.5 | Yes |
| Example 52 | Glass | In | Sea-island | 55 | 28.5 | 10.3 | SiO₂ | 1.46 | 61.7 | 90.1 | Yes |
| Example 53 | Glass | In | Sea-island | 55 | 27.2 | 10.3 | SiO₂ | 1.46 | 76.3 | 111.4 | Yes |
| Example 54 | Glass | In | Sea-island | 55 | 24.3 | 10.2 | SiO₂ | 1.46 | 91.1 | 133.0 | Yes |
| Comparative | Glass | In | Sea-island | — | — | 0 | Cr₂O₃ | 2.5 | 48.8 | 122.0 | Yes |
| Example 28 | | | | | | | | | | | |
| Example 55 | Glass | In | Sea-island | 87 | 8 | 2.7 | Cr₂O₃ | 2.5 | 45.4 | 113.5 | Yes |
| Example 56 | Glass | In | Sea-island | 83 | 8 | 3.1 | Cr₂O₃ | 2.5 | 36.6 | 91.5 | Yes |
| Example 57 | Glass | In | Sea-island | 82 | 8.5 | 5.2 | Cr₂O₃ | 2.5 | 41.3 | 103.3 | Yes |
| Example 58 | Glass | In | Sea-island | 45 | 11.2 | 7.7 | Cr₂O₃ | 2.5 | 32.7 | 81.8 | Yes |
| Example 59 | Glass | In | Sea-island | 55 | 16.9 | 10.2 | Cr₂O₃ | 2.5 | 34.1 | 85.3 | Yes |
| Example 60 | Glass | In | Sea-island | 38 | 21.2 | 12.6 | Cr₂O₃ | 2.5 | 33.3 | 83.3 | Yes |
| Example 61 | Glass | In | Sea-island | 33 | 34.7 | 15.2 | Cr₂O₃ | 2.5 | 34.5 | 86.3 | Yes |
| Example 62 | Glass | In | Sea-island | 25 | 49 | 20.2 | Cr₂O₃ | 2.5 | 32.9 | 82.3 | Yes |
| Example 63 | Glass | In | Sea-island | 12 | 56.4 | 28.8 | Cr₂O₃ | 2.5 | 37.9 | 94.8 | Yes |
| Example 64 | Glass | In | Sea-island | 8 | 52.7 | 50.2 | Cr₂O₃ | 2.5 | 38 | 95.0 | Yes |
| Example 65 | Glass | In | Sea-island | 55 | 18.4 | 7.9 | SiO₂ | 1.46 | 32.8 | 47.9 | Yes |
| Example 66 | Glass | In | Sea-island | 55 | 18.6 | 7.3 | SiO₂ | 1.46 | 30.2 | 44.1 | Yes |
| Example 67 | Glass | In | Sea-island | 55 | 18.3 | 8.3 | SiO₂ | 1.46 | 29.4 | 42.9 | Yes |
| Example 68 | Glass | In | Sea-island | 55 | 18.5 | 8.1 | SiO₂ | 1.46 | 27.1 | 39.6 | Yes |
| Example 69 | Glass | In | Sea-island | 55 | 18.2 | 8.8 | SiO₂ | 1.46 | 26.2 | 38.3 | Yes |
| Example 70 | Glass | In | Sea-island | 55 | 18.5 | 8.2 | SiO₂ | 1.46 | 31.2 | 45.6 | Yes |
| Comparative | Glass | In | Sea-island | 85 | 8.2 | 5.2 | Cr₂O₃ | 2.5 | 44.4 | 111.0 | Yes |
| Example 29 | | | | | | | | | | | |
| Example 71 | Glass | In | Sea-island | 85 | 8.5 | 5.1 | Cr₂O₃ | 2.5 | 39.9 | 99.8 | Yes |
| Example 72 | Glass | In | Sea-island | 85 | 8.3 | 5.1 | Cr₂O₃ | 2.5 | 46.8 | 117.0 | Yes |
| Example 73 | Glass | In | Sea-island | 85 | 8.4 | 5.1 | Cr₂O₃ | 2.5 | 47.7 | 119.3 | Yes |
| Example 74 | Glass | In | Sea-island | 85 | 8.4 | 5.1 | Cr₂O₃ | 2.5 | 40.2 | 100.5 | Yes |
| Example 75 | Glass | In | Sea-island | 85 | 8.4 | 5.2 | Cr₂O₃ | 2.5 | 45.2 | 113.0 | Yes |
| Example 76 | Glass | In | Sea-island | 55 | 26.2 | 10.3 | Al₂O₃ | 1.63 | 40.3 | 65.7 | Yes |
| Example 77 | Glass | In | Sea-island | 55 | 24 | 10.3 | Al₂O₃ | 1.63 | 40.8 | 66.5 | Yes |
| Example 78 | Glass | In | Sea-island | 55 | 24.7 | 10.3 | Al₂O₃ | 1.63 | 44.6 | 72.7 | Yes |
| Example 79 | Glass | In | Sea-island | 55 | 22.8 | 10.3 | Al₂O₃ | 1.63 | 49.6 | 80.8 | Yes |

| | Structure | | | | Evaluation | | | | |
|---|---|---|---|---|---|---|---|---|---|
| | Ray reflective metal | | | | Appearance | | | Electro- | |
| | coating film | | | | | | Coloring | magnetic | |
| | | | Light | | | | dependency on | Permeability | |
| | Material | Structure | reflectance (%) | Thickness (nm) | Coloring | Brightness | the view angle | 2 GHz | 76 GHz |
| Example 29 | In | Sea-island | 63 | 45 | Yellow | Medium | No | ◯ | ◯ |
| Example 30 | In | Sea-island | 63 | 45 | Yellow | Medium | No | ◯ | ◯ |
| Example 31 | In | Sea-island | 63 | 45 | Yellow | Medium | No | ◯ | ◯ |
| Example 32 | In | Sea-island | 63 | 45 | Yellow ~ | Medium | No | ◯ | ◯ |
| | | | | | Purple | | | | |
| Example 33 | In | Sea-island | 60 | 40 | Yellow | Medium | No | ◯ | ◯ |
| Comparative | In | Sea-island | 60 | 40 | Yellow | High | Yes | ◯ | ◯ |
| Example 27 | | | | | | | | | |
| Example 34 | In | Sea-island | 60 | 40 | Red | Medium | No | ◯ | ◯ |
| | | | | | purple | | | | |
| Example 35 | In | Sea-island | 60 | 40 | Blue | Medium | No | ◯ | ◯ |
| | | | | | green | | | | |
| Example 36 | Al | Continuous | 85 | 40 | Blue | Medium | No | X | X |
| Example 37 | In | Sea-island | 60 | 40 | Purple | Medium | No | ◯ | ◯ |
| Example 38 | In | Sea-island | 60 | 40 | Blue | Medium | No | ◯ | ◯ |
| | | | | | purple | | | | |
| Example 39 | In | Sea-island | 64 | 50 | Blue | Medium | No | ◯ | ◯ |
| Example 40 | In | Sea-island | 64 | 50 | Blue | Medium | No | ◯ | ◯ |
| Example 41 | In | Sea-island | 64 | 50 | Blue | Medium | No | ◯ | ◯ |
| Example 42 | In | Sea-island | 45 | 20.3 | None | Medium | No | ◯ | ◯ |
| Example 43 | In | Sea-island | 45 | 20.2 | Indigo | Medium | No | ◯ | ◯ |
| Example 44 | In | Sea-island | 45 | 20.3 | Blue | Medium | No | ◯ | ◯ |
| Example 45 | In | Sea-island | 45 | 20.3 | Blue | Medium | No | ◯ | ◯ |
| Example 46 | In | Sea-island | 45 | 20.3 | Blue | Medium | No | ◯ | ◯ |
| Example 47 | In | Sea-island | 45 | 20.4 | None | Medium | No | ◯ | ◯ |
| Example 48 | In | Sea-island | 45 | 20.3 | Yellow | Medium | No | ◯ | ◯ |
| | | | | | (light) | | | | |
| Example 49 | In | Sea-island | 45 | 20.3 | Red | Medium | No | ◯ | ◯ |
| Example 50 | In | Sea-island | 45 | 20.3 | Blue | Medium | No | ◯ | ◯ |
| Example 51 | In | Sea-island | 45 | 20.3 | Blue | Medium | No | ◯ | ◯ |
| Example 52 | In | Sea-island | 45 | 20.3 | Blue | Medium | No | ◯ | ◯ |
| | | | | | (light) | | | | |
| Example 53 | In | Sea-island | 45 | 20.3 | Blue | Medium | No | ◯ | ◯ |
| | | | | | (light) | | | | |
| Example 54 | In | Sea-island | 45 | 20.3 | None | Medium | No | ◯ | ◯ |
| Comparative | In | Sea-island | 45 | 20.1 | None | Medium | No | ◯ | ◯ |
| Example 28 | | | | | | | | | |
| Example 55 | In | Sea-island | 45 | 20.1 | Red | Medium | No | ◯ | ◯ |
| | | | | | (light) | | | | |
| Example 56 | In | Sea-island | 45 | 20.2 | Red | Medium | No | ◯ | ◯ |
| Example 57 | In | Sea-island | 45 | 20.1 | Purple | Medium | No | ◯ | ◯ |
| Example 58 | In | Sea-island | 45 | 20.1 | Indigo | Medium | No | ◯ | ◯ |
| Example 59 | In | Sea-island | 45 | 20.1 | Blue | Medium | No | ◯ | ◯ |
| Example 60 | In | Sea-island | 45 | 20.2 | Blue | Medium | No | ◯ | ◯ |
| Example 61 | In | Sea-island | 45 | 20.2 | Blue | Medium | No | ◯ | ◯ |
| | | | | | (light) | | | | |
| Example 62 | In | Sea-island | 45 | 20.2 | None | Medium | No | ◯ | ◯ |
| Example 63 | In | Sea-island | 45 | 20.2 | Red | Medium | No | ◯ | ◯ |
| | | | | | (light) | | | | |
| Example 64 | In | Sea-island | 45 | 20.2 | Blue | Medium | No | ◯ | ◯ |
| | | | | | (light) | | | | |
| Example 65 | In | Sea-island | 65 | 70.3 | Red | Medium | No | ◯ | ◯ |
| | | | | | (light) | | | | |
| Example 66 | In | Sea-island | 63 | 50.3 | Red | Medium | No | ◯ | ◯ |
| | | | | | (light) | | | | |
| Example 67 | In | Sea-island | 60 | 40.3 | Red | Medium | No | ◯ | ◯ |
| | | | | | (light) | | | | |
| Example 68 | In | Sea-island | 57 | 30.3 | Red | Medium | No | ◯ | ◯ |
| Example 69 | In | Sea-island | 48 | 23.3 | Red | Medium | No | ◯ | ◯ |
| Example 70 | In | Sea-island | 45 | 20.3 | Red | Medium | No | ◯ | ◯ |
| Comparative | In | Sea-island | — | 0 | None | Medium | No | ◯ | ◯ |
| Example 29 | | | | | | | | | |
| Example 71 | In | Sea-island | 25 | 10.2 | Red | Medium | No | ◯ | ◯ |
| | | | | | (light) | | | | |
| Example 72 | In | Sea-island | 45 | 20.2 | Red | Medium | No | ◯ | ◯ |
| Example 73 | In | Sea-island | 57 | 30.1 | Red | Medium | No | ◯ | ◯ |
| | | | | | (light) | | | | |
| Example 74 | In | Sea-island | 60 | 40.2 | Red | Medium | No | ◯ | ◯ |
| | | | | | (light) | | | | |
| Example 75 | In | Sea-island | 68 | 100 | Red | Medium | No | ◯ | ◯ |
| | | | | | (light) | | | | |
| Example 76 | In | Sea-island | 60 | 40.4 | Blue | Medium | No | ◯ | ◯ |
| | | | | | (light) | | | | |
| Example 77 | In | Sea-island | 57 | 30.3 | Blue | Medium | No | ◯ | ◯ |
| Example 78 | In | Sea-island | 45 | 20.3 | Blue | Medium | No | ◯ | ◯ |
| Example 79 | In | Sea-island | 64 | 50.3 | Blue | Medium | No | ◯ | ◯ |
| | | | | | (light) | | | | |

Samples of the examples and reference examples were prepared as follows.
1) First, a semi-transparent metal coating film was formed by vacuum deposition on a plate-like surface layer (120×100 mm, thickness: 3 mm for PC and acrylic, 1 mm for glass).
2) A light interference transparent film was next similarly formed by vacuum deposition on the formed semi-transparent metal coating film.
3) A ray reflective metal coating film was further similarly formed by vacuum deposition on the formed light interference transparent film.
4) On the color luminous designed film thus formed as explained above (on the ray reflective metal coating film), a two component acrylic urethane-based paint (black) was coated so as to have a thickness of 30 μm. Thereafter, a film was formed under the curing conditions of 120 minutes at 80° C. to create the sample.

It should be noted that depending on the sample, an undercoat for deposition was coated on the surface of the plate-like surface layer.

For the deposition apparatus, an electron beam (EB) deposition device made by Shincron Co., Ltd. was used. Deposition films were formed by crucible exchange. For the film formation conditions, the degree of vacuum was equal to or less than 5×10⁻³ Pa or 2×10⁻³ Pa, the sample (plate-like body) temperature was 50° C., and the growth rate was 0.3 nm/s. When necessary, the morphology of the light interference transparent film is controlled to achieve an uneven surface by reducing the GR (gas ratio) during formation of the light interference transparent film. Note that surfaces not subjected to such morphology control are smooth.

In order to control the thicknesses of the respective films, a crystal oscillator type film thickness meter and an optical film thickness meter (light wavelength: 505 nm) were used.

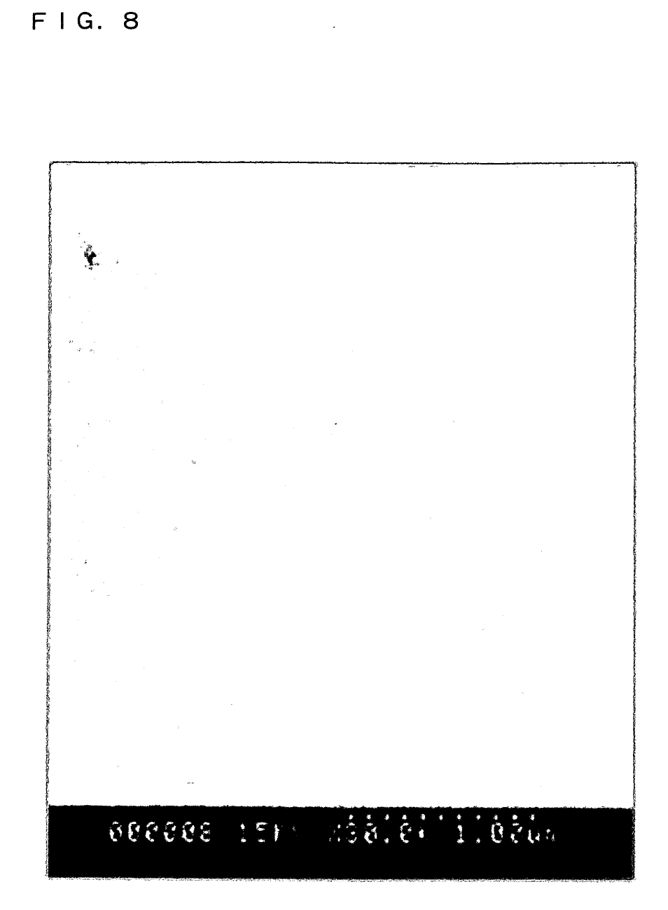

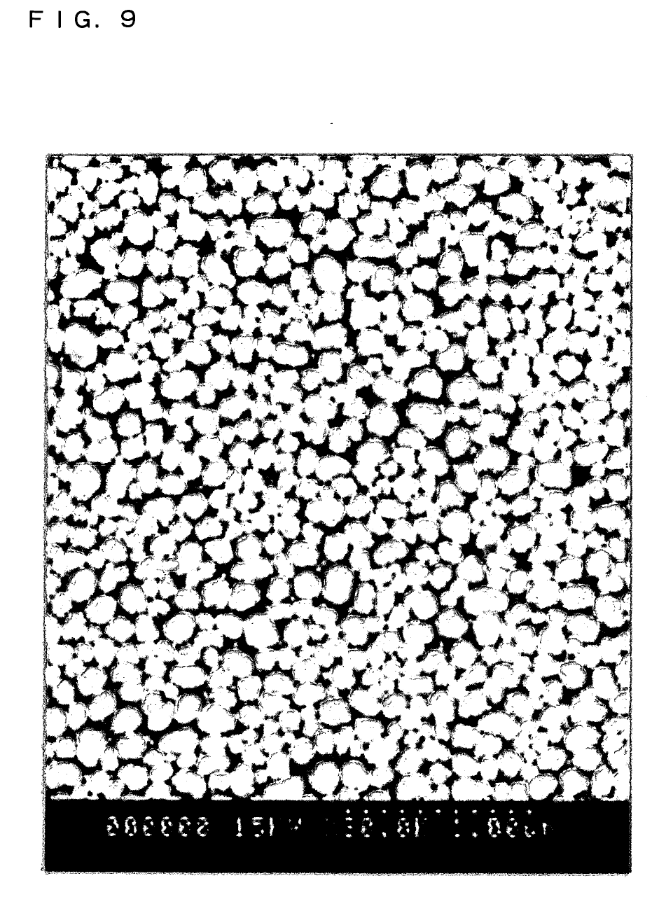

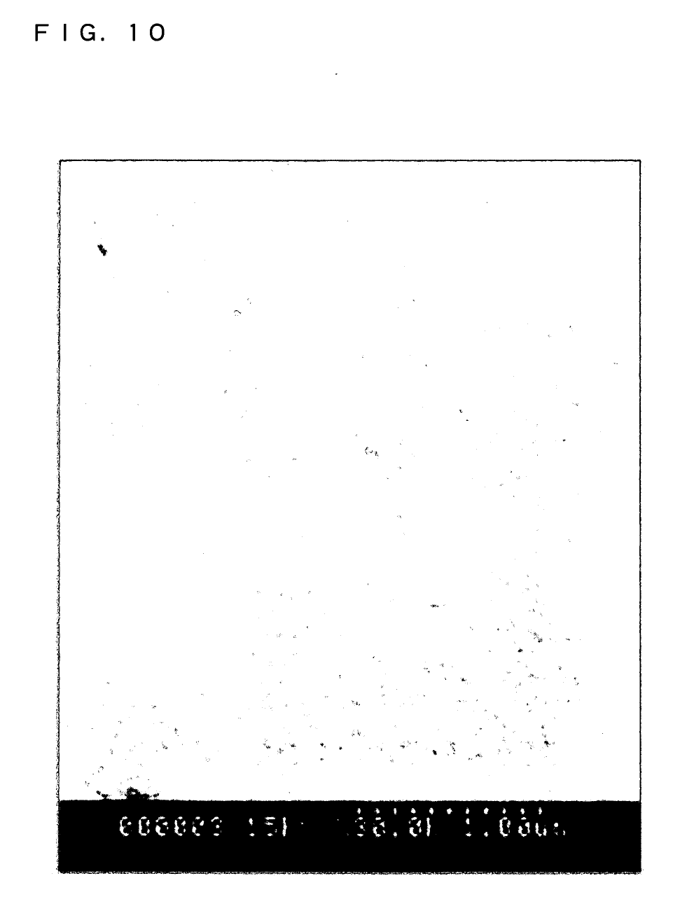

Among the color luminous designed films (before coating of the two component acrylic urethane-based paint) prepared as explained above, micrographs were taken from a surface opposite the surface layers (polycarbonate substrates) of Comparative Example 25 (continuous film) and Comparative Example 8 (sea-island film), as well as the surface layer of a polycarbonate substrate formed with an indium coating (In, thickness: 10 nm) on which a chromium oxide film (CrOₓ, thickness: 80 nm) was further formed. FIGS. 8, 9, and 10 respectively show the micrographs.

The samples were measured and evaluated as follows.

### (1) Appearance

The coloring (coloration), brightness, and the coloring dependency on the view angle which is a property where the coloring changes by the change in view angle, were measured from the surface layer side (the semi-transparent metal film side of the color luminous designed film).

### (1-1) Coloring

The coloring was measured using a calorimeter.

### (1-2) Brightness

The level of brightness was measured using a gloss meter.

(1-3)

Changes (differences) in coloring (coloration) was visually measured from two view angles: a view angle set in a direction perpendicular to the flat surface of the sample body (substrate), and a view angle set in a direction where a 60° angle is formed with the perpendicular line. Note that some samples were measured using a plate-like body (actual product) with an uneven surface as the surface layer.

Based on the measurement results, the following effects were obtained for each element regarding coloring and brightness.
According to Examples 1 to 6 and Comparative Examples 1 to 5, there were changes in brightness due to the thickness of the semi-transparent metal coating film.
According to Examples 7 to 15 and Comparative Examples 6 to 12, there were changes in coloring due to the thickness (optical thickness) of the light interference transparent film.
According to Comparative Examples 13 and 14, there was a tendency toward cloudiness at a light interference transparent film thickness of 300 nm or more.
According to Comparative Examples 15 to 20, there were changes in coloring and brightness due to the thickness of the ray reflective metal coating film. Further, brightness lowered at 10 nm or less.
According to Comparative Examples 21 to 25, the metal coating film using aluminum had more of a coloring tendency than the metal coating film using indium, and higher brightness.
According to Examples 16 to 19, there were changes in the coloring concentration and brightness due to the thickness of the semi-transparent metal coating film.
According to Examples 20 to 28 and Comparative Example 26, there were changes in coloring due to the material (metal) of the metal coating film.
According to Examples 20 to 37 and Comparative Example 27, there were changes in coloring due to the material of the light interference transparent film.

Based on the measurement results, the following effects were obtained for each element regarding the coloring dependency on the view angle.
According to Examples 1 to 15 and Comparative Examples 6 to 14, those whose light interference transparent film had a thin thickness (optical thickness) showed a small coloring dependency on thickness, which is a property where the coloring changes due to non-uniform thicknesses. Therefore, no rainbow coloring occurred even when there were variations in thickness due to the contour of the surface layer. There was also no coloring dependency on the view angle. Those whose light interference transparent film had a thick thickness showed a large coloring dependency on thickness, and rainbow coloring occurred as a result of variations in thickness due to the contour of the surface layer. There was also a coloring dependency on the view angle as well.
According to Examples 16 to 19 and Comparative Examples 21 to 25, there was a coloring dependency on the view angle when at least either the semi-transparent metal coating film or the ray reflective metal coating film was a continuous film.

### (2) Electromagnetic Permeability

The samples were placed between an electromagnetic transmitter and receiver. A 2 GHz (electromagnetic wave used in a mobile phone) and a 76 GHz (millimeter wave) electromagnetic waves were sent from the transmitter. Measurements were performed regarding whether the receiver was capable of detection to evaluate electromagnetic permeability. Note that the receiver was provided with an electromagnetic shield that blocked electromagnetic waves from directions other the direction of the sample.
O: Detected, X: Undetected

Based on the measurement results, the following effects were obtained for each element regarding electromagnetic permeability.
According to Examples 1 to 15 and Comparative Examples 1 to 12, the use of indium in the metal coating film (with a sea-island structure) produces electromagnetic permeability.
According to Comparative Examples 15 to 20, electromagnetic permeability deteriorated when the thickness of the ray reflective metal coating film is 100 nm or more.
According to Examples 16 to 19 and Comparative Examples 21 to 25, the use of aluminum as the metal in the ray reflective metal coating film (with a continuous structure) results in no electromagnetic permeability.
According to Examples 20 to 25 and Comparative Example 26, there was electromagnetic permeability in the case of a thin semi-transparent metal coating film (with a continuous structure) and a ray reflective metal coating film with a sea-island structure.
According to Examples 29 to 41 and Comparative Example 27, there was electromagnetic permeability if the light interference transparent film was a dielectric inorganic compound (oxide or nitride).

The following Table 4 summarizes the measurements and evaluations of appearance and electromagnetic permeability regarding six types of Examples A1 to A6 and four types of Comparative Examples B1 to B4, all of whose structures have been modified (the surface layer was eliminated and a substrate was provided under the ray reflective metal coating film).

Note that the method for measuring and evaluating the appearance and electromagnetic permeability was the same as described above. However, for film formation, the sample preparation method (film formation sequence) alone was performed in the opposite order of the above-described method (where the ray reflective metal coating film is first formed on the substrate, after which the light interference transparent film and then the semi-transparent metal coating film are formed in that order)

TABLE 4

| | Structure | | | | | | | | | |
|---|---|---|---|---|---|---|---|---|---|---|
| | | Ray reflective metal | | | | Light interference | | | | |
| | | coating film | | | | transparent film | | | | |
| | | | | Light | | | | | Optical | |
| | Substrate | | | reflectance | Thickness | | Refractive | Thickness | thickness | Morphology |
| | Material | Material | Structure | (%) | (nm) | Material | index | (nm) | (nm) | control |
| Example A1 | Black ABS | In | Sea-island | 64 | 50 | Cr₂O₃ | 2.5 | 30 | 75 | Yes |
| Comparative | Black ABS | In | Sea-island | 60 | 40 | Cr₂O₃ | 2.5 | 80 | 200 | Yes |
| Example B1 | | | | | | | | | | |
| Example A2 | Acrylic | In | Sea-island | 64 | 50 | Cr₂O₃ | 2.5 | 30 | 75 | Yes |
| Comparative | Acrylic | In | Sea-island | 60 | 40 | Cr₂O₃ | 2.5 | 80 | 200 | Yes |
| Example B2 | | | | | | | | | | |
| Example A3 | Glass | In | Sea-island | 64 | 50 | Cr₂O₃ | 2.5 | 30 | 75 | Yes |
| Comparative | Glass | In | Sea-island | 60 | 40 | Cr₂O₃ | 2.5 | 80 | 200 | Yes |
| Example B3 | | | | | | | | | | |
| Example A4 | PC | In | Sea-island | 64 | 50 | Cr₂O₃ | 2.5 | 30 | 75 | Yes |
| Comparative | PC | In | Sea-island | 60 | 40 | Cr₂O₃ | 2.5 | 80 | 200 | Yes |
| Example B4 | | | | | | | | | | |
| Example A5 | PC | Sn | Sea-island | 60 | 40 | Cr₂O₃ | 2.5 | 30 | 75 | Yes |
| Example A6 | PC | Sn | Sea-island | 60 | 40 | Cr₂O₃ | 2.5 | 35 | 87.5 | Yes |

| | Structure | | | | | | | | | |
|---|---|---|---|---|---|---|---|---|---|---|
| | Semi-transparent metal | | | | | Evaluation | | | | |
| | coating film | | | | | Appearance | | | Electro- | |
| | | | Light | Light | | | | Coloring | magnetic | |
| | | | transmittance | reflectance | Thickness | | | dependency on | permeability | |
| | Material | Structure | (%) | (%) | (nm) | Coloring | Brightness | the view angle | 2 GHz | 76 GHz |
| Example A1 | In | Sea-island | 55 | 18 | 10 | Blue | Medium | No | ◯ | ◯ |
| Comparative | In | Sea-island | 55 | 18 | 10 | Yellow | High | Yes | ◯ | ◯ |
| Example B1 | | | | | | | | | | |
| Example A2 | In | Sea-island | 55 | 18 | 10 | Blue | Medium | No | ◯ | ◯ |
| Comparative | In | Sea-island | 55 | 18 | 10 | Yellow | High | Yes | ◯ | ◯ |
| Example B2 | | | | | | | | | | |
| Example A3 | In | Sea-island | 55 | 18 | 10 | Blue | Medium | No | ◯ | ◯ |
| Comparative | In | Sea-island | 55 | 18 | 10 | Yellow | High | Yes | ◯ | ◯ |
| Example B3 | | | | | | | | | | |
| Example A4 | In | Sea-island | 55 | 18 | 10 | Blue | Medium | No | ◯ | ◯ |
| Comparative | In | Sea-island | 55 | 18 | 10 | Yellow | High | Yes | ◯ | ◯ |
| Example B4 | | | | | | | | | | |
| Example A5 | In | Sea-island | 55 | 18 | 10 | Blue | Medium | No | ◯ | ◯ |
| Example A6 | In | Sea-island | 55 | 18 | 10 | Blue | Medium | No | ◯ | ◯ |

Based on the measurements and evaluations of the appearance and electromagnetic permeability of the Examples and Comparative Examples listed in Table 4, the effects obtained were identical to those obtained with the samples listed in Tables 2 and 3, despite that elimination of the surface layer and use of a structure that provides a substrate under the ray reflective metal coating film.

The following Table 5 summarizes the measurements and evaluations of appearance and electromagnetic permeability regarding four types of Examples C1 to C4, all of whose color luminous designed films have a second transparent film for interference formed from an inorganic compound on the semi-transparent metal coating film (under the surface layer). The semi-transparent metal coating film and the ray reflective metal coating film have sea-island structures.

Note that the sample preparation method (except for first forming the second transparent film on the surface layer), as well as the method for measuring and evaluating the appearance and electromagnetic permeability, were the same as those used for the samples listed in Tables 2 and 3.

TABLE 5

| | Structure | | | | | | | |
|---|---|---|---|---|---|---|---|---|
| | | | | | | | Semi- | |
| | | | | | | | Transparent | |
| | | Second transparent | | | | | metal | |
| | | film | | | | | coating | |
| | | | | | Optical thickness | | film | |
| | Surface layer Material | Material | Refractive index | Thickness (nm) | (nm) | Morphology control | Material | Thickness (nm) |
| Example C1 | PC | SiO₂ | 1.46 | 5 | 7.3 | No | In | 10 |
| Example C2 | PC | Cr₂O₃ | 2.5 | 5 | 12.5 | No | In | 5 |
| Example C3 | PC | SiO₂ | 1.46 | 80 | 116.8 | No | In | 10 |
| Example C4 | PC | Cr₂O₃ | 2.5 | 80 | 200 | No | In | 5 |

| | Structure | | | | | | | Evaluation | | | | |
|---|---|---|---|---|---|---|---|---|---|---|---|---|
| | Light | | | | | Ray | | Appearance | | | | |
| | interference | | | | | reflective metal | | | | Coloring | | |
| | transparent film | | | | | coating film | | | | dependency | Electro- | |
| | | | | Optical | | | Thick- | | | on the | magnetic | |
| | | Refractive | Thickness | thickness | Morphology | | ness | | Bright- | view | Permeability | |
| | Material | index | (nm) | (nm) | control | Material | (nm) | Coloring | ness | angle | 2 GHz | 76 GHz |
| Example C1 | SiO₂ | 1.46 | 15 | 21.9 | Yes | In | 45 | Blue | Medium | No | ◯ | ◯ |
| | | | | | | | | purple | | | | |
| Example C2 | Cr₂O₃ | 2.5 | 15 | 37.5 | Yes | In | 45 | Blue | Medium | No | ◯ | ◯ |
| Example C3 | SiO₂ | 1.46 | 15 | 21.9 | Yes | In | 45 | Green | Medium | No | ◯ | ◯ |
| Example C4 | Cr₂O₃ | 2.5 | 15 | 37.5 | Yes | In | 45 | Green | Medium | No | ◯ | ◯ |
| | | | | | | | | blue | | | | |

Based on the results of Examples C1 to C4 listed in Table 5, by providing the second transparent film for interference formed from an inorganic compound on the semi-transparent metal coating film, two interference colors color and thus produces more coloring (increases the degree of freedom for coloring).

According to the above results, all of the (89 types of) Examples hardly generated changes in coloring due to the view direction (angle), that is, all of the Examples had a small coloring dependency on the view angle. Furthermore, (79 types of) Examples other than Examples 16 to 19, 21, 22, 24, 26, 28, and 36 also exhibited electromagnetic permeability.

Note that the present invention is not limited to the above Examples, and may also be realized with other suitable modifications that fall within the scope of the invention.

Further note for reference that an invention involving an electromagnetic permeable resin product that is colored by an interference color (including rainbow coloring) and that has electromagnetic permeability can be derived from the description of the present invention.

Specifically, an electromagnetic permeable resin product is colored by a color luminous designed film on a surface layer formed from a transparent resin, wherein the color luminous designed film includes a semi-transparent metal coating film having a discontinuous structure, or having a continuous structure with a thickness of 1 to 20 nm, a light interference transparent film formed from a dielectric in organic compound on the semi-transparent metal coating film, and a ray reflective metal coating film having a discontinuous structure on the light interference transparent film.

Applicable embodiments of such an invention are Examples 1 to 15, 20, 23, 25, 27, 29 to 35, 37 to 41, C1 to C4, and Comparative Examples 1 to 19, and 27.

Additionally, an electromagnetic permeable resin product is colored by a color luminous designed film on a resin substrate, wherein the color luminous designed film includes a ray reflective metal coating film having a discontinuous structure, a light interference transparent film formed from a dielectric inorganic compound on the ray reflective metal coating film, and a semi-transparent metal coating film having a discontinuous structure, or having a continuous structure with a thickness of 1 to 20 nm, on the light interference transparent film.

Applicable embodiments of such an invention are Examples A1, A2, A4 to A6, and Comparative Examples B1, B2, and B4.

What is claimed is:

1. An apparatus housing and an apparatus decoration, comprising:
a color luminous designed film which colors the apparatus housing and the apparatus decoration, the color luminous designed film comprising:
a semi-transparent metal coating film;
a light interference transparent film which has an optical thickness of 5 to 150 nm and is formed from an inorganic compound, under the semi-transparent metal coating film; and
a ray reflective metal coating film under the light interference transparent film.

2. The apparatus housing and the apparatus decoration according to claim 1, wherein
the semi-transparent metal coating film has 10 to 90% light transmittance in a wavelength range of 400 to 800 nm, and has 3 to 60% light reflectance in the wavelength range of 400 to 800 nm.

3. The apparatus housing and the apparatus decoration according to claim 1, wherein
the semi-transparent metal coating film is a film with a discontinuous structure, and the film with the discontinuous structure has a thickness of 2 to 50 nm.

4. The apparatus housing and the apparatus decoration according to claim 2, wherein
the semi-transparent metal coating film is a film with a discontinuous structure, and the film with the discontinuous structure has a thickness of 2 to 50 nm.

5. The apparatus housing and the apparatus decoration according to claim 1, wherein
the semi-transparent metal coating film is a continuous film, and the continuous film has a thickness of 1 to 20 nm.

6. The apparatus housing and the apparatus decoration according to claim 2, wherein
the semi-transparent metal coating film is a continuous film, and the continuous film has a thickness of 1 to 20 nm.

7. The apparatus housing and the apparatus decoration according to claim 1, wherein
the light interference transparent film has a surface made uneven by morphology control during film formation.

8. The apparatus housing and the apparatus decoration according to claim 5, wherein
the light interference transparent film has a surface made uneven by morphology control during film formation.

9. The apparatus housing and the apparatus decoration according to claim 1, wherein
the ray reflective metal coating film has 30% light reflectance or more in a wavelength range of 400 to 800 nm.

10. The apparatus housing and the apparatus decoration according to claim 7, wherein
the ray reflective metal coating film has 30% light reflectance or more in a wavelength range of 400 to 800 nm.

11. The apparatus housing and the apparatus decoration according to claim 1, wherein
the color luminous designed film further comprises a second transparent film formed from an inorganic compound on the semi-transparent metal coating film.

12. The apparatus housing and the apparatus decoration according to claim 9, wherein
the color luminous designed film further comprises a second transparent film formed from an inorganic compound on the semi-transparent metal coating film.

13. The apparatus housing and the apparatus decoration according to claim 1, further comprising:
a surface layer formed from one of a transparent resin and glass on the color luminous designed film.

14. The apparatus housing and the apparatus decoration according to claim 11, further comprising:
a surface layer formed from one of a transparent resin and glass on the color luminous designed film.

15. The apparatus housing and the apparatus decoration according to claim 1, wherein
the inorganic compound is a dielectric, and
the ray reflective metal coating film is a film with a discontinuous structure, whereby
the apparatus housing the apparatus decoration have electromagnetic permeability.

16. The apparatus housing and the apparatus decoration according to claim 13, wherein
the inorganic compound is a dielectric, and
the ray reflective metal coating film is a film with a discontinuous structure, whereby
the apparatus housing the apparatus decoration have electromagnetic permeability.

17. The apparatus housing and the apparatus decoration according to claim 1, wherein
the inorganic compound is one of an oxide and a nitride.

18. The apparatus housing and the apparatus decoration according to claim 15, wherein
the inorganic compound is one of an oxide and a nitride.
